(19) United States
(12) Patent Application Publication
(10) Pub. No.: US 2025/0022633 A1
(43) Pub. Date: Jan. 16, 2025

(54) LIQUID-COOLED CABLE

(71) Applicant: Changchun Jetty Automotive Technology Co., Ltd., Changchun, Jilin (CN)

(72) Inventors: Chao WANG, Changchun, Jilin (CN); Qingxin GAI, Changchun, Jilin (CN)

(73) Assignee: Changchun Jetty Automotive Technology Co., Ltd., Changchun, Jilin (CN)

(21) Appl. No.: 18/714,465

(22) PCT Filed: Nov. 11, 2022
(86) PCT No.: PCT/CN2022/131367

§ 371 Date: May 29, 2024

(30) Foreign Application Priority Data
Nov. 30, 2021 (CN) 202111444463.3

(51) Int. Cl. H01B 7/42; H01B 7/02

(52) U.S. Cl. CPC H01B 7/423; H01B 7/02

(57) ABSTRACT

The present disclosure provides a liquid-cooled cable, including a liquid cooling channel and at least one set of cable cores (1) with a cross section in a shape of fan. The liquid cooling channel includes an internal liquid cooling channel (2), an external liquid cooling channel (3), and at least one set of connecting channels (4). The external liquid cooling channel (3) communicates with the internal liquid cooling channel (2) via the connecting channels (4), and a cooling medium flows in the liquid cooling channel. The cable cores (1) are disposed at an outer periphery of the internal liquid cooling channel (2) and an inner periphery of the external liquid cooling channel (3), and the connecting channels (4) are disposed at a radial direction of the liquid-cooled cable and separate the cable cores (1). The present disclosure increases the liquid cooling channels inside and outside the cable cores, maximizing the cooling effect of the cable, thus enhancing the flow carrying capacity of the cable and prolonging the service life.

### RELATED APPLICATIONS

This application claims priority to Chinese Patent Application No. 202111444463.3, filed on Nov. 30, 2021 and entitled “LIQUID-COOLED CABLE”.

### FIELD OF TECHNOLOGY

The present disclosure relates to the field of cable technologies, and in particular to a liquid-cooled cable.

### BACKGROUND

A cable typically includes a conductor, an insulator, and a sheath. When transmitting current, the conductor generates heat due to its inherent resistance. New energy vehicles currently charge slowly, and increasing the charging speed through high-power charging is a future development trend. The greater the power, the more heat generated by the cable itself. Increasing the cable diameter results in increased cable weight, and long-term usage accelerates the aging of the cable, shortening the service life of the cables.

Therefore, based on many years of experience and practice in the relevant industry, the inventor of this patent proposes a liquid-cooled cable to overcome the shortcomings in the prior art.

### SUMMARY

An objective of the present disclosure is to provide a liquid-cooled cable, so as to resolve the problems in the prior art. The present disclosure increases the liquid cooling channels inside and outside the cable cores, maximizing the cooling effect of the cable, thus enhancing the flow carrying capacity of the cable, reducing the cable weight, and prolonging the service life of the cable.

The objective of the present disclosure is achieved as follows: A liquid-cooled cable is provided, including a liquid cooling channel and at least one set of cable cores with a cross section in a shape of fan. The liquid cooling channel includes an internal liquid cooling channel, an external liquid cooling channel, and at least one set of connecting channels. The external liquid cooling channel communicates with the internal liquid cooling channel via the connecting channels, and a cooling medium flows in the liquid cooling channel. The cable cores are disposed at an outer periphery of the internal liquid cooling channel and an inner periphery of the external liquid cooling channel, and the connecting channels are disposed at a radial direction of the liquid-cooled cable and separate the cable cores.

Based on the foregoing description, the liquid-cooled cable in the present disclosure has the following beneficial effects:
1. In the liquid-cooled cable provided by the present disclosure, the liquid cooling channels are increased inside and outside the cable cores, maximizing the cooling effect of the cable, thus enhancing the flow carrying capacity of the cable and prolonging the service life. An outer sheath layer can effectively protect a structure therein.
2. In the liquid-cooled cable provided by the present disclosure, the cable core is configured into the shape of a fan, with each fan-shaped cable core surrounding the outer wall of a circular internal liquid cooling channel. Compared with the arrangement where the circular cable cores with the same cross-section area surround the outer wall of the internal liquid cooling channel, that the fan-shaped cable cores surround an outer wall of the circular internal liquid cooling channel obtains a smaller cable diameter and facilitates production of miniaturized cables, cable weight reduction, storage and management, and cable movement.

### BRIEF DESCRIPTION OF THE DRAWINGS

To describe the technical solutions in the embodiments of the present disclosure more clearly, the following briefly describes the accompanying drawings required for description of the embodiments. Apparently, the accompanying drawings in the following description show only some embodiments of the present disclosure, and persons of ordinary skill in the art may still derive other drawings from these accompanying drawings without creative efforts.

In which:

FIG. 1 is a schematic cross-sectional view where an outer periphery of each cable core of a liquid-cooled cable of the present disclosure is coated with an insulating layer and a shielding structure, and an outer side of an external liquid cooling channel is provided with an inner sheath, a shielding structure, and an outer sheath layer.

FIG. 2 is a schematic cross-sectional view where an outer periphery of each cable core of a liquid-cooled cable of the present disclosure is coated with an insulating layer and a shielding structure, and an outer side of an external liquid cooling channel is provided with a shielding structure and an outer sheath layer.

FIG. 3 is a schematic cross-sectional view where an outer periphery of a cable core of a liquid-cooled cable of the present disclosure is coated with an insulating layer, and an outer side of an external liquid cooling channel is provided with a shielding structure and an outer sheath layer.

FIG. 4 is a schematic cross-sectional view where an outer periphery of a cable core of a liquid-cooled cable of the present disclosure is coated with an insulating layer, and an outer side of an external liquid cooling channel is provided with an inner sheath, a shielding structure, and an outer sheath layer.

FIG. 5 is a schematic cross-sectional view where an outer periphery of each cable core of a liquid-cooled cable of the present disclosure is coated with an insulating layer and a shielding structure, and an outer side of an external liquid cooling channel is provided with an outer sheath layer.

FIG. 6 is a schematic cross-sectional view where an outer periphery of a cable core of a liquid-cooled cable of the present disclosure is coated with an insulating layer and a shielding structure, and an outer side of an external liquid cooling channel is provided with an inner sheath, a shielding structure, and an outer sheath layer.

FIG. 7 is a schematic cross-sectional view where an outer periphery of a cable core of a liquid-cooled cable of the present disclosure is coated with an insulating layer and a shielding structure, and an outer side of an external liquid cooling channel is provided with a shielding structure and an outer sheath layer.

FIG. 8 is a schematic cross-sectional view where multiple cable cores of a liquid-cooled cable of the present disclosure are disposed in a radial direction of the liquid-cooled cable, and an outer side of an external liquid cooling channel is provided with an inner sheath, a shielding structure, and an outer sheath layer.

FIG. 9 is a schematic cross-sectional view where each cable core of a liquid-cooled cable of the present disclosure is in a shape of a semicircular fan, and an outer side of an external liquid cooling channel is provided with an inner sheath, a shielding structure, and an outer sheath layer.

FIG. 10 is a schematic cross-sectional view where a liquid-cooled cable of the present disclosure includes a cable core, and an outer side of an external liquid cooling channel is provided with an inner sheath, a shielding structure, and an outer sheath layer.

FIG. 11 is a schematic structural diagram of a first support structure being a strip plate-like body according to the present disclosure.

FIG. 12 is a schematic cross-sectional view where two adjacent cable cores of a liquid-cooled cable of the present disclosure form a shape of a semicircular fan, and an outer side of an external liquid cooling channel is provided with an inner sheath, a shielding structure, and an outer sheath layer.

### DESCRIPTION OF THE EMBODIMENTS

In order to provide a clearer understanding of the technical features, purpose and effect of the present disclosure, the specific implementations of the present disclosure are described with reference to the accompanying drawings.

The specific implementations of the present disclosure described herein are solely for explaining the purpose of the present disclosure and should not be construed in any way as limiting the present disclosure. Referring to the concept of the present disclosure, persons of ordinary skill can conceive of any possible variations based on the present disclosure, and these should be considered as within the scope of the present disclosure. It should be noted that when a component is referred to as being “disposed on” another component, it may be directly disposed on the another component, or there may be intermediary components present. When a component is deemed as being “connected to” another component, it may be directly connected to the another component, or there may be intermediary components present. The terms “mount”, “join”, and “connect” should be broadly interpreted. For example, they can refer to mechanical or electrical connection, internal communication of two components, direct connection, or indirect connection through an intermediary medium. For persons of ordinary skill in the art, the specific meanings of the above terms can be understood based on the specific circumstances. The terms “vertical”, “horizontal”, “up”, “down”, “left”, “right”, and similar expressions used in this embodiment are solely for explanatory purposes and do not indicate the only implementation.

Unless otherwise defined, all technical and scientific terms used herein shall have the same meanings as commonly understood by those skilled in the art to which this application pertains. The terms used in the embodiment of this application are merely intended to describe specific embodiments but not intended to limit this application. The term “and/or” used herein includes any and all combinations of one or more associated items listed.

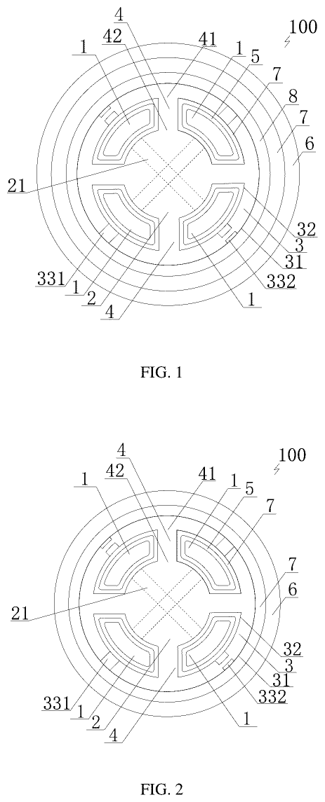

As shown in FIGS. 1 to 12, the present disclosure provides a liquid-cooled cable 100, including a liquid cooling channel and at least one set of cable cores 1 with a cross section in a shape of fan. The liquid cooling channel includes an internal liquid cooling channel 2, an external liquid cooling channel 3, and at least one set of connecting channels 4. The external liquid cooling channel 3 communicates with the internal liquid cooling channel 2 via the connecting channels 4, and a cooling medium flows in the liquid cooling channel. The cable cores 1 are disposed at an outer periphery of the internal liquid cooling channel 2 and an inner periphery of the external liquid cooling channel 3, and the connecting channels 4 are disposed at a radial direction of the liquid-cooled cable and separate the cable cores 1. The internal liquid cooling channel 2 and the external liquid cooling channel 3 are made of a highly conductive material.

In the liquid-cooled cable provided by present disclosure, the liquid cooling channels are increased inside and outside the cable cores, maximizing the cooling effect of the cable, so as to enhancing the flow carrying capacity of the cable and prolonging the service life.

By arranging the connecting channel 4, the cross section around the fan-shaped cable core 1 in the vertical direction may be liquid cooling, maximizing the cooling effect of the cable, so as to enhancing the flow carrying capacity of the cable and prolonging the service life.

In the liquid-cooled cable provided by the present disclosure, the cable core is configured into the shape of a fan, with each fan-shaped cable core surrounding the outer wall of a circular internal liquid cooling channel. Compared with the arrangement where the circular cable cores with the same cross-section area surround the outer wall of the internal liquid cooling channel, that the fan-shaped cable cores surround an outer wall of the circular internal liquid cooling channel obtains a smaller cable diameter and facilitates production of miniaturized cables, cable weight reduction, storage and management, and cable movement.

In specific embodiments, it is assumed that a radius of the circular internal liquid cooling channel is r, and four fan-shaped cable cores whose radii are all 2r and angle radians are all 900 surround an outer wall of the internal liquid cooling channel to form a circular ring area of S1. According to a formula S=[(2r)²−r²]π, the calculation yields that the area of each fan-shaped cable core S2=[(2r)²−r²]π/4=0.25[(2r)²−r²]π. If the cross-sectional area of the circular cable core is made equal to S2, the radius of the circular cable core is obtained: R²=0.25[(2r)²−r²]π/π=0.75r², so R=0.866r, and the diameter d=1.732r. Therefore, if the circular cable cores with the same cross-sectional area surround an outer wall of a circular internal liquid cooling tube, the cable radius is the distance from the central axis of the circular internal liquid cooling pipe to the farthest point on the circular wire core from the central axis of the liquid cooling pipe r+d=r+1.732r=2.732r. For the cable configured by fan-shaped cable cores with the same cross-sectional area surround the outer wall of a circular internal liquid cooling tube, the cable radius is the distance from the central axis of the circular internal liquid cooling pipe to the farthest point on the circular wire core from the central axis of the liquid cooling pipe 2r. Thus, it can be known that compared with the arrangement where the circular cable cores with the same cross-section area surround the outer wall of the internal liquid cooling channel, that the fan-shaped cable cores surround an outer wall of the circular internal liquid cooling channel obtains a smaller cable diameter.

The material of the liquid cooling channel includes one or more of polyvinyl chloride, polyethylene, polyamide, polytetrafluoroethylene, tetrafluoroethylene/hexafluoropropylene copolymer, ethylene/tetrafluoroethylene copolymer, polypropylene, polyvinylidene fluoride, polyurethane, polyterephthalic acid, polyurethane elastomer, styrene block copolymer, perfluoroalkoxyalkane, chlorinated polyethylene, polyphenylene sulphide, polystyrene, silicone rubber, crosslinked polyolefin, ethylene propylene rubber, ethylene/vinyl acetate copolymer, neoprene rubber, natural rubber, styrene-butadiene rubber, nitrile butadiene rubber, butadiene rubber, isoprene rubber, ethylene-propylene rubber, chloroprene rubber, butyl rubber, fluoro rubber, polyurethane rubber, polyacrylate rubber, chlorosulphonated polyethylene rubber, epichlorohydrin rubber, chlorinated polyethylene rubber, chlorosulphur rubber, styrene butadiene rubber, butadiene rubber, hydrogenated nitrile rubber, polysulfide rubber, cross-linked polyethylene, polycarbonate, polysulfone, polyphenylene ether, polyester, phenolic resin, urea-formaldehyde, styrene-acrylonitrile copolymer, polymethylmethacrylate, and polyoxymethylene resin.

In specific embodiments, the cooling medium may be selected from one or more of castor oil, coconut oil, corn oil, cottonseed oil, flaxseed oil, olive oil, palm oil, peanut oil, grape seed oil, rapeseed oil, safflower oil, sunflower oil, soybean oil, a plant oil high-oleic variant, decen-4-oic acid, decenoic acid, lauric acid, epirubicin, tetradecenoic acid, whale wax acid, crude oil acid, palm oil acid, celery acid, oleic acid, octadecenoic acid, codenoic acid, giant whale acid, whale wax acid, erucic acid, and neurological acid, glycerin, transformer oil, axle oil, internal combustion engine oil, and compressor oil. An additive may be added into a cooling oil, and is selected from one or more of antioxidant, pour point depressant, corrosion inhibitor, antimicrobial agent, and viscosity modifier. The cooling oil possesses a sensitive heat balancing capability, exceptional heat conductivity, and an extraordinarily wide operating temperature range, precludes boiling and vaporization, maintains a micro-pressure of a cooling system, requires no antifreeze in a low-temperature environment, avoids corrosion damage such as cavitation, scaling, and electrolysis, and has other advantages. In specific embodiment, as long as the cooling liquid can cool the cable, it falls into the protection scope of the present disclosure and is not particularly limited herein.

Further, as shown in FIGS. 1 to 10, the external liquid cooling channel 3 includes a first tube body 31 and a second tube body 32. The first tube body 31 sleeves the second tube body 32. The external liquid cooling channel 3 further includes at least one first support structure and the first support structure is connected to an inner wall of the first tube body and an outer wall of the second tube body. The first support structure can ensure the stability of the external liquid cooling channel 3 and smooth flowing of the cooling liquid in the external liquid cooling channel 3.

Further, as shown in FIGS. 1 to 10, each of the connecting channels 4 has a first via hole 41 and a second via hole 42 at two ends, the first via hole 41 runs through a tube wall of the second tube body 32, and the second via hole 42 runs through a tube wall of the internal liquid cooling channel 2. This can achieve communication between the internal liquid cooling channel 2 and the external liquid cooling channel 3. The present disclosure does not particularly limit the connection manner of the connecting channel 4 provided that the internal liquid cooling channel 2 communicates with the external liquid cooling channel 3.

Further, as shown in FIG. 11, each first support structure is a plurality of sets of columnar structures 331; and/or each first support structure is a strip plate-like body 332, and the strip plate-like body 332 is provided with a through hole 333. With the arrangement of the plurality of sets of columnar structures 331 and/or the strip plate-like body 332 with the through hole 333, the structural stability of the external liquid cooling channel 3 is increased, and realize the internal communication inside the external liquid cooling channel 3, such that the cooling medium is not limited to flow through the entire external liquid cooling channel 3.

Further, each of the connecting channels 4 has two sets of side walls, and the two sets of side walls rotate around a central axis of the internal liquid cooling channel; or the two sets of side walls are parallel to the central axis of the internal liquid cooling channel. The arrangement manner of the two sets of side walls of each connecting channel 4 is not limited particularly, provided that the production and user requirements are met.

Further, as shown in FIGS. 1 to 7, an outer periphery of at least one cable core 1 is sleeved with an insulating layer 5. The outer periphery of the cable core 1 being sleeved with the insulating layer 5 can protect the cable core 1 while enhancing the safety of the liquid-cooled cable during use.

In specific embodiments, the insulating layer includes one or more of polyvinyl chloride, polyethylene, polyamide, polytetrafluoroethylene, tetrafluoroethylene/hexafluoropropylene copolymer, ethylene/tetrafluoroethylene copolymer, polypropylene, polyvinylidene fluoride, polyurethane, polyterephthalic acid, polyurethane elastomer, styrene block copolymer, perfluoroalkoxyalkane, chlorinated polyethylene, polyphenylene sulphide, polystyrene, silicone rubber, crosslinked polyolefin, ethylene propylene rubber, ethylene/vinyl acetate copolymer, neoprene rubber, natural rubber, styrene-butadiene rubber, nitrile butadiene rubber, butadiene rubber, isoprene rubber, ethylene-propylene rubber, chloroprene rubber, butyl rubber, fluoro rubber, polyurethane rubber, polyacrylate rubber, chlorosulphonated polyethylene rubber, epichlorohydrin rubber, chlorinated polyethylene rubber, chlorosulphur rubber, styrene butadiene rubber, butadiene rubber, hydrogenated nitrile rubber, polysulfide rubber, cross-linked polyethylene, polycarbonate, polysulfone, polyphenylene ether, polyester, phenolic resin, urea-formaldehyde, styrene-acrylonitrile copolymer, polymethylmethacrylate, and polyoxymethylene resin.

Further, as shown in FIG. 8, multiple cable cores 1 are arranged in a radial direction of the liquid-cooled cable. In specific embodiment, when multiple cable cores 1 are arranged in the radial direction of the liquid-cooled cable, in a case of keeping the cross-sectional area of each cable core 1 and the quantity of the cable cores 1 unchanged, compared with separately arranging cable cores 1 with the same cross-sectional area in the radial direction of the liquid-cooled cable, arranging the multiple cable cores 1 in the radial direction of the liquid-cooled cable allows for a smaller farthest distance from the cable core 1 to the central axis of the liquid-cooled cable and reduces the cross-sectional area of the liquid-cooled cable, facilitating use and increasing the application scenarios.

In specific embodiment, when the multiple cable cores 1 are arranged in the radial direction of the liquid-cooled cable, the insulating layer 5 should be additionally disposed on an outer side of the cable core 1, ensuring insulation between each two of the multiple cable cores 1 disposed radially without communication.

In specific embodiment, when the multiple cable cores 1 are arranged in the radial direction of the liquid-cooled cable, a liquid cooling channel may be disposed between the cable cores 1 disposed radially, thus further ensuring the effect of cooling the cable.

Further, as shown in FIGS. 1 to 10, the liquid-cooled cable 100 further includes an outer sheath layer 6, and the outer sheath layer 6 is disposed at an outermost periphery of the liquid-cooled cable. The outer sheath layer 6 can effectively protect its internal structure therein and prolong the service life of the liquid-cooled cable.

Further, as shown in FIGS. 1 to 10, the liquid-cooled cable 100 further includes a shielding structure 7, and an outer periphery of the first tube body 31 is sleeved with the shielding structure 7; and/or an outer periphery of the at least one cable core 1 is sleeved with an insulating layer 5, and an outer periphery of the at least one insulating layer 5 is sleeved with the shielding structure 7. The shielding structure 7 can conduct part of heat outward to ensure the effect of cooling the cable core, and isolate the electromagnetic field in the cable core 1 from the external electromagnetic field to reduce interference with the surroundings.

In this embodiment, the shielding structure 7 is a metal shielding layer and configured to radially conduct thermal energy outwards and reduce interference with the surroundings. The shielding structure 7 may be a metal strip, a metal wire, a conductive plastic, or a conductive rubber, and the shielding structure 7 is made through one or more of processes such as coil wrapping, longitudinal wrapping, braiding, helical wrapping, metal armoring, or extrusion.

Further, the shielding structure 7 sleeving the outer side of the insulating layer 5 of the cable core 1 or the shielding structure 7 sleeving the outer periphery of the first tube body 31 has a thickness greater than or equal to 38 μm, and the corresponding shielding structure 7 sleeving the outer periphery of the first tube body 31 or shielding structure 7 sleeving the outer side of the insulating layer 5 of the cable core 1 has a thickness smaller than 38 μm.

The thickness of the shielding structure 7 sleeving the outer side of the insulating layer 5 of the cable core 1 or the shielding structure 7 sleeving the outer periphery of the first tube body 31, and the thickness of the corresponding shielding structure 7 sleeving the outer periphery of the first tube body 31 or shielding structure 7 sleeving the outer side of the insulating layer 5 of the cable core 1 may be determined based on requirements and limited times experiments. Exemplarily, the thickness of one shielding sleeve is greater than or equal to 38 μm, and the other corresponding shielding sleeve is less than 38 μm. To verify the effect of the thickness of the shielding sleeve on the flow carrying capability of the shielding sleeve, the inventor separately selects different thicknesses for the shielding structure 7 sleeving the outer side of the insulating layer 5 of the cable core 1 and the shielding structure 7 sleeving the outer periphery of the first tube body 31, to separately test the shielding performance of liquid-cooled cables. In this embodiment, an ideal shielding performance value of the liquid-cooled cable is greater than 40 dB.

In a specific embodiment, the insulating layer 5 and the shielding structure 7 are both disposed outside each cable core 1 for testing the shielding performance value of the liquid-cooled cable.

The method for testing a shielding performance value: A tester outputs a signal value (which is test value 2) to the liquid-cooled cable, a detection apparatus is disposed outside the liquid-cooled cable, and the detection apparatus detects a signal value (which is test value 1). Shielding performance value=test value 2−test value 1.

TABLE 1
Effect of a thickness of a shielding structure 7 sleeving an outer side of
an insulating layer 5 of a cable core 1 or a shielding structure 7 sleeving
an outer periphery of a first tube body 31 on shielding performance

| | Thickness of the shielding structure 7 sleeving the outer side of the insulating | | | | | | | | |
|---|---|---|---|---|---|---|---|---|---|
| | layer 5 of the cable core 1 or the shielding structure 7 sleeving the outer | | | | | | | | |
| | periphery of the first tube body 31 (μm) | | | | | | | | |
| Test | 8 | 18 | 28 | 38 | 48 | 58 | 68 | 78 | 88 |
| parameter | | | | | | | | | |
| Frequency | | | | | | | | | |
| greater | | | | | | | | | |
| than 5 | | | | | | | | | |
| MHz | | | | | | | | | |
| Shielding | 24 | 31 | 35 | 37 | 44 | 46 | 50 | 53 | 57 |
| performance | | | | | | | | | |
| value | | | | | | | | | |
| (dB) | | | | | | | | | |
| | Thickness of the shielding structure 7 sleeving the outer side of the insulating | | | | | | | | |
| | layer 5 of the cable core 1 or shielding structure 7 sleeving the outer periphery | | | | | | | | |
| | of the first tube body 31 (μm) | | | | | | | | |
| Test | 8 | 18 | 28 | 38 | 48 | 58 | 68 | 78 | 88 |
| parameter | | | | | | | | | |
| Frequency | | | | | | | | | |
| less than | | | | | | | | | |
| 5 MHz | | | | | | | | | |
| Shielding | 53 | 47 | 43 | 38 | 36 | 33 | 28 | 25 | 21 |
| performance | | | | | | | | | |
| value | | | | | | | | | |
| (dB) | | | | | | | | | |

It can be seen from Table 1 that when the test frequency is greater than 5 MHz, the thickness of the shielding structure 7 sleeving the outer side of the insulating layer 5 of the cable core 1 or the shielding structure 7 sleeving the outer periphery of the first tube body 31 is less than 38 μm, and the shielding performance value of the liquid-cooled cable is qualified. When the test frequency is less than 5 MHz, the thickness of the shielding structure 7 sleeving the outer side of the insulating layer 5 of the cable core 1 or the shielding structure 7 sleeving the outer periphery of the first tube body 31 is greater than 38 μm, and the shielding performance value of the liquid-cooled cable is qualified. Therefore, as the shielding structure 7 sleeving the outer side of the insulating layer 5 of the cable core 1 or the shielding structure 7 sleeving the outer periphery of the first tube body 31 respectively use different thicknesses, the interference signals across all frequencies can be shielded, thus ensuring the shielding performance of the liquid-cooled cable. Therefore, the inventor sets the thickness of the shielding structure 7 sleeving the outer side of the insulating layer 5 of the cable core 1 or the shielding structure 7 sleeving the outer periphery of the first tube body 31 to be greater than or equal to 38 μm, and the corresponding shielding structure 7 sleeving the outer periphery of the first tube body 31 or shielding structure 7 sleeving the outer side of the insulating layer 5 of the cable core 1 to be less than 38 μm.

Further, as shown in FIGS. 1, 4, 6, 8, 9, and 10, the liquid-cooled cable 100 further includes an inner sheath 8, the outer periphery of the first tube body 31 is sleeved with the inner sheath 8, and the outer periphery of the inner sheath 8 is sleeved with a shielding structure 7.

The arrangement of the inner sheath 8 can protect the liquid cooling channel, avoiding damage to the liquid cooling channel. Meanwhile, arranging the shielding structure 7 on the outer side of the inner sheath 8 can improve the stability of the shielding structure 7, avoiding damage to the shielding structure 7.

The material of the inner sheath or the outer sheath includes one or more of polyvinyl chloride, polyethylene, polyamide, polytetrafluoroethylene, tetrafluoroethylene/hexafluoropropylene copolymer, ethylene/tetrafluoroethylene copolymer, polypropylene, polyvinylidene fluoride, polyurethane, polyterephthalic acid, polyurethane elastomer, styrene block copolymer, perfluoroalkoxyalkane, chlorinated polyethylene, polyphenylene sulphide, polystyrene, silicone rubber, crosslinked polyolefin, ethylene propylene rubber, ethylene/vinyl acetate copolymer, neoprene rubber, natural rubber, styrene-butadiene rubber, nitrile butadiene rubber, butadiene rubber, isoprene rubber, ethylene-propylene rubber, chloroprene rubber, butyl rubber, fluoro rubber, polyurethane rubber, polyacrylate rubber, chlorosulphonated polyethylene rubber, epichlorohydrin rubber, chlorinated polyethylene rubber, chlorosulphur rubber, styrene butadiene rubber, butadiene rubber, hydrogenated nitrile rubber, polysulfide rubber, cross-linked polyethylene, polycarbonate, polysulfone, polyphenylene ether, polyester, phenolic resin, urea-formaldehyde, styrene-acrylonitrile copolymer, polymethylmethacrylate, and polyoxymethylene resin.

Further, the internal liquid cooling channel 2 further includes at least one set of second support structures 21, the second support structure 21 supports and connects an inner wall of the internal liquid cooling channel 2, the second support structure 21 is a strip plate-like body 332, and the strip plate-like body is provided with a plurality of sets of through holes 333; and/or the second support structure 21 is a plurality of sets of columnar structures.

In a specific embodiment, the arrangement of the second support structure 21 prevents an external force from enabling the inner walls of the internal liquid cooling channel to contact each other, where such contact causes the internal liquid cooling channel to be blocked and thus the cooling medium cannot flow in the internal liquid cooling channel.

Further, a ratio of an inner cavity cross-sectional area of the internal liquid cooling channel 2 to a cross-sectional area sum of the cable cores 1 is 2% to 60%.

To verify the effect of the ratio of the inner cavity cross-sectional area of the internal liquid cooling channel 2 to a cross-sectional area sum of the cable cores 1 on temperature rising of the liquid-cooled cable, the inventor selects the liquid-cooled cables with the same structure, external liquid cooling channels 3 with the same cross-sectional area, and matched running cable cores 1 with the same cross-sectional area sum. During test, liquid-cooled cables with different ratios of inner cavity cross-sectional areas of internal liquid cooling channels 2 to a cross-sectional area sum of the cable cores 1 are used for temperature rising test.

The method for temperature rising test: In a closed environment, liquid-cooled cables with different ratios of inner cavity cross-sectional areas of the internal liquid cooling channels 2 to the cross-sectional area sum of cable cores 1 are used, the same current is conducted, and the temperature of the liquid-cooled cable before energization and the temperature of the liquid-cooled cable when the temperature is stable after energization are recorded to take an absolute value by difference. In this embodiment, a temperature rise value less than 50 k is qualified.

TABLE 2
Effect of a ratio of an inner cavity cross-sectional area of an
internal liquid cooling channel 2 to a cross-sectional area sum
of cable cores 1 on temperature rising of a liquid-cooled cable
Ratio of inner cavity cross-sectional area of internal liquid cooling channel
2 to cross-sectional area sum of cable cores 1 (%)

| | | | | | | | | | | | |
|---|---|---|---|---|---|---|---|---|---|---|---|
| 0.5 | 1 | 2 | 16 | 23 | 32 | 45 | 49 | 56 | 60 | 68 | 72 |

Temperature rise of liquid-cooled cable (K)

| | | | | | | | | | | | |
|---|---|---|---|---|---|---|---|---|---|---|---|
| 58 | 52 | 48 | 44 | 40 | 37 | 33 | 29 | 25 | 21 | 20 | 20 |

It can be seen from Table 2 that when the ratio of the inner cavity cross-sectional area of the internal liquid cooling channel 2 to the cross-sectional area sum of the cable cores 1 is less than 2%, because the internal cross-sectional area of the internal liquid cooling channel 2 is small and the cooling medium flowing in the internal liquid cooling channel 2 has a small volume and cannot timely take away the heat generated by the cable cores due to current conduction, the liquid-cooled cable has a high temperature and the temperature rise value of the liquid-cooled cable is greater than 50 k, the temperature rise value is unqualified. When the ratio of the inner cavity cross-sectional area of the internal liquid cooling channel 2 to the cross-sectional area sum of the cable cores 1 is greater than or equal to 2%, the cooling medium in the internal liquid cooling channel 2 has a large volume percentage and can timely take away the heat generated by the cable cores due to current conduction, and the temperature rise value of the liquid-cooled cable is less than 50 k. However, as the ratio of the inner cavity cross-sectional area of the internal liquid cooling channel 2 to the cross-sectional area sum of the cable cores 1 continuously increases to 60%, the temperature rise value decreases and becomes stable, no longer showing the decrease tendency. However, in this case, the large internal cross-sectional area of the internal liquid cooling channel 2 results in a large outer diameter of the liquid-cooled cable, the outer diameter of the liquid-cooled cable at this moment is larger than an outer diameter of a normal cable that conducts the same current and has no liquid cooling channel, and thus using liquid-cooled cables has no practical optimization value. So, the inventor selects the ratio of the inner cavity cross-sectional area of the internal liquid cooling channel 2 to the cross-sectional area sum of the cable cores 1 to be 2% to 60%.

Further, a ratio of an inner cavity cross-sectional area of the external liquid cooling channel 3 to the cross-sectional area sum of the cable cores 1 is 2% to 60%.

To verify the effect of the ratio of the inner cavity cross-sectional area of the external liquid cooling channel 3 to the cross-sectional area sum of the cable cores 1 on temperature rising of the liquid-cooled cable, the inventor selects the liquid-cooled cables with the same structure, internal liquid cooling channels 2 with the same cross-sectional area, and matched running cable cores with the same cross-sectional area sum. During test, liquid-cooled cables with different ratios of inner cavity cross-sectional areas of external liquid cooling channels 3 to a cross-sectional area sum of the cable cores 1 are used for temperature rising test.

The method for temperature rising test: In a closed environment, liquid-cooled cables with different ratios of inner cavity cross-sectional areas of the external liquid cooling channels 3 to the cross-sectional area sum of cable cores 1 are used, the same current is conducted, and the temperature of the liquid-cooled cable before energization and the temperature of the liquid-cooled cable when the temperature is stable after energization are recorded to take an absolute value by difference. In this embodiment, a temperature rise value less than 50 k is qualified.

TABLE 3
Effect of a ratio of an inner cavity cross-sectional area of an
external liquid cooling channel 3 to a cross-sectional area sum
of cable cores 1 on temperature rising of a liquid-cooled cable
Ratio of inner cavity cross-sectional area of external liquid cooling
channel 3 to cross- sectional area sum of cable cores 1 (%)

| | | | | | | | | | | | |
|---|---|---|---|---|---|---|---|---|---|---|---|
| 0.5 | 1 | 2 | 19 | 24 | 35 | 44 | 51 | 56 | 60 | 69 | 75 |

Temperature rise of liquid-cooled cable (K)

| | | | | | | | | | | | |
|---|---|---|---|---|---|---|---|---|---|---|---|
| 58 | 52 | 48 | 44 | 40 | 37 | 33 | 29 | 25 | 21 | 20 | 20 |

It can be seen from Table 3 that when the ratio of the inner cavity cross-sectional area of the external liquid cooling channel 3 to the cross-sectional area sum of the cable cores 1 is less than 2%, because the internal cross-sectional area of the external liquid cooling channel 3 is small and the cooling medium flowing therein has a small volume and cannot timely take away the heat generated by the cable cores due to current conduction, the liquid-cooled cable has a high temperature and the temperature rise value of the liquid-cooled cable is greater than 50 k, unqualified. When the ratio of the inner cavity cross-sectional area of the external liquid cooling channel 3 to the cross-sectional area sum of the cable cores 1 is greater than or equal to 2%, the cooling medium in the external liquid cooling channel 3 has a large volume percentage and can timely take away the heat generated by the cable cores 1 due to current conduction, and the temperature rise value of the liquid-cooled cable is less than 50 k. However, as the ratio of the inner cavity cross-sectional area of the external liquid cooling channel 3 to the cross-sectional area sum of the cable cores 1 continuously increases to 60%, the temperature rise value decreases and becomes stable, no longer showing the decrease tendency. Furthermore, in this case, the large internal cross-sectional area of the external liquid cooling channel 3 results in a large outer diameter of the liquid-cooled cable, the outer diameter of the liquid-cooled cable at this moment is larger than an outer diameter of a normal cable that conducts the same current and has no liquid cooling channel, and thus using liquid-cooled cables has no practical optimization value. Further, the inventor selects the ratio of the inner cavity cross-sectional area of the external liquid cooling channel 3 to the cross-sectional area sum of the cable cores 1 to be 2% to 60%.

Further, a ratio of a distance between two side walls of the connecting channel 4 to a circumference of the internal liquid cooling channel 2 is 5% to 45%.

To verify the effect of the ratio of a distance between two side walls of the connecting channel 4 to the circumference of the internal liquid cooling channel 2 on temperature rising of the liquid-cooled cable, the inventor uses the liquid-cooled cables with the same structure. During test, these liquid-cooled cables, having different ratios of the distances between two side walls of the connecting channels 4 to circumferences of the internal liquid cooling channels 2, are used for temperature rising test.

The method for temperature rising test: In a closed environment, liquid-cooled cables, having different ratios of the distances between two side walls of the connecting channels 4 to circumferences of the internal liquid cooling channels 2 are used, the same current is conducted, and the temperature of the liquid-cooled cable before energization and the temperature of the liquid-cooled cable when the temperature is stable after energization are recorded to take an absolute value by difference. In this embodiment, a temperature rise value less than 50 k is qualified.

TABLE 4
Effect of a ratio of a distance between two side walls of a connecting
channel 4 to a circumference of an internal liquid cooling channel
2 on temperature rising of a liquid-cooled cable
Ratio of distance between two side walls of connecting channel 4 to circumference
of internal liquid cooling channel 2 (%)

| | | | | | | | | | | | |
|---|---|---|---|---|---|---|---|---|---|---|---|
| 1 | 3 | 5 | 9 | 14 | 22 | 28 | 34 | 39 | 45 | 60 | 71 |

Temperature rise of liquid-cooled cable (K)

| | | | | | | | | | | | |
|---|---|---|---|---|---|---|---|---|---|---|---|
| 57 | 54 | 49 | 43 | 39 | 35 | 33 | 28 | 25 | 20 | 19 | 19 |

It can be seen from Table 4 that when the ratio of the distance between two side walls of the connecting channel 4 to the circumference of the internal liquid cooling channel 2 is less than 5%, because the connecting channel 4 cannot enable good flowing of the cooling medium between the internal liquid cooling channel 2 and the external liquid cooling channel 3 and the cooling medium flowing in the connecting channel 4 has a small volume and cannot timely take away the heat generated by the cable cores 1 on two sides of the connecting channel 4 due to current conduction, the liquid-cooled cable has a high temperature and the temperature rise value of the liquid-cooled cable is greater than 50 k, the temperature rise value is unqualified. When the ratio of the distance between two side walls of the connecting channel 4 to the circumference of the internal liquid cooling channel 2 is greater than or equal to 45%, good flowing of the cooling medium between the internal liquid cooling channel 2 and the external liquid cooling channel 3 can be enabled, the cooling medium in the connecting channel 4 has a large volume percentage and can timely take away the heat generated by the cable cores 1 on two sides of the connecting channel 4 due to current conduction, and the temperature rise value of the liquid-cooled cable is less than 50 k. However, as the ratio of the distance between two side walls of the connecting channel 4 to the circumference of the internal liquid cooling channel 2 increases to 45%, the temperature rise value decreases and becomes stable, no longer showing the decrease tendency. In this case, continuous increase in the ratio is meaningless. Therefore, the inventor needs to set the ratio of the distance between two side walls of the connecting channel 4 to the circumference of the internal liquid cooling channel 2 to be 5% to 45%.

Further, a ratio of a circumferential total width of the first support structure to a circumference of the external liquid cooling channel 3 is 4% to 54%.

When the first support structure is a strip plate-like body 332, to verify the effect of the ratio of the circumferential total width of the first support structure to the circumference of the external liquid cooling channel 3 on temperature rising of the liquid-cooled cable, the inventor uses the liquid-cooled cables with the same structure. During test, these liquid-cooled cables, having different ratios of circumferential total widths of the first support structures to circumferences of external liquid cooling channels 3, are used for temperature rising test.

The method for temperature rising test: In a closed environment, liquid-cooled cables with different ratios of circumferential total widths of the first support structures to circumferences of external liquid cooling channels are used, the same current is conducted, and the temperature of the liquid-cooled cable before energization and the temperature of the liquid-cooled cable when the temperature is stable after energization are recorded to take an absolute value by difference. In this embodiment, the temperature rise value less than 50 k is qualified while it should be ensured that the external liquid cooling channel does not deform. If the external liquid cooling channel 3 deforms, the value is also unqualified.

TABLE 5
Effect of a ratio of a circumferential total width of a first
support structure to a circumference of an external liquid cooling
channel 3 on temperature rising of a liquid-cooled cable
Ratio of circumferential total width of the first support structure
to circumference of external liquid cooling channel 3 (%)

| | | | | | | | | | | | |
|---|---|---|---|---|---|---|---|---|---|---|---|
| 1 | 2 | 4 | 21 | 27 | 31 | 38 | 44 | 49 | 54 | 61 | 73 |

Temperature rise of liquid-cooled cable (K)

| | | | | | | | | | | | |
|---|---|---|---|---|---|---|---|---|---|---|---|
| 0 | 0 | 24 | 27 | 29 | 31 | 34 | 38 | 42 | 49 | 57 | 71 |

Whether the external liquid cooling channel 3 deforms

| | | | | | | | | | | | |
|---|---|---|---|---|---|---|---|---|---|---|---|
| Yes | Yes | No | No | No | No | No | No | No | No | No | No |

It can be seen from Table 5 that when the ratio of the circumferential total width of the first support structure to the circumference of the external liquid cooling channel 3 is less than 4%, because the external liquid cooling channel 3 deforms, it is unnecessary to conduct the temperature rise test on it. When the ratio of the circumferential total width of the first support structure to the circumference of an external liquid cooling channel 3 is greater than 54%, because the percentage of the first support structure is large, the percentage of the cooling medium flowing in the external liquid cooling channel 3 is small, and the heat generated by the cable cores on two sides of the external liquid cooling channel 3 due to current conduction cannot be taken away, the temperature of the liquid-cooled cable is high and the temperature rise value of the liquid-cooled cable is greater than 50 K, unqualified. Therefore, the inventor selects the ratio of the circumferential total width of the first support structure to the circumference of an external liquid cooling channel 3 to be 4% to 54%.

Further, a ratio of a circumferential total width of the second support structure 21 to an inner diameter of the internal liquid cooling channel 2 is 3% to 20%.

When the second support structure 21 is a strip plate-like body 332, to verify the effect of the ratio of the circumferential total width of the second support structure 21 to the inner diameter of the internal liquid cooling channel 2 on temperature rising of the liquid-cooled cable, the inventor uses the liquid-cooled cables with the same structure. During test, these liquid-cooled cables, having different ratios of circumferential widths of the second support structures 21 to inner diameters of internal liquid cooling channels 2, are used for temperature rising test.

The method for temperature rising test: In a closed environment, liquid-cooled cables with different ratios of circumferential total widths of the second support structures 21 to inner diameters of internal liquid cooling channels are used, the same current is conducted, and the temperature of the liquid-cooled cable before energization and the temperature of the liquid-cooled cable when the temperature is stable after energization are recorded to take an absolute value by difference. In this embodiment, the temperature rise value less than 50 k is qualified while it should be ensured that the internal liquid cooling channel 2 does not deform. If the internal liquid cooling channel 2 deforms, the value is also unqualified.

TABLE 6
Effect of a ratio of a circumferential total width of a second support
structure 21 to an inner diameter of an internal liquid cooling
channel 2 on temperature rising of a liquid-cooled cable
Ratio of circumferential total width of second support structure 21
to inner diameter of internal liquid cooling channel 2 (%)

| | | | | | | | | | | | |
|---|---|---|---|---|---|---|---|---|---|---|---|
| 1 | 2 | 3 | 5 | 7 | 10 | 12 | 15 | 18 | 20 | 25 | 45 |

Temperature rise of liquid-cooled cable (K)

| | | | | | | | | | | | |
|---|---|---|---|---|---|---|---|---|---|---|---|
| 19 | 20 | 25 | 27 | 29 | 31 | 33 | 39 | 43 | 48 | 55 | 69 |

It can be seen from Table 6 that when the ratio of the circumferential width of the second support structure 21 to the inner diameter of the internal liquid cooling channel 2 is less than 3%, although the temperature rise value of the liquid-cooled cable is less than 50 k, the ratio of the circumferential width of the second support structure 21 to the inner diameter of the internal liquid cooling channel 2 is excessively small, resulting in difficult production. When the ratio of the circumferential total width of the second support structure 21 to the inner diameter of the internal liquid cooling channel 2 is greater than 20%, the temperature rise value of the liquid-cooled cable is greater than 50 K, so the temperature rise value is unqualified. Therefore, the ratio of the circumferential width of the second support structure 21 to the inner diameter of the internal liquid cooling channel is 3% to 20%.

Further, the liquid-cooled cable 100 further includes a liquid cooling circulation pump. The liquid cooling circulation pump communicates with the liquid cooling channel via a communication tube, and the liquid cooling circulation pump is configured to circulate and cool the cooling medium in the liquid cooling channel. The cooling medium is used to take away the heat generated by the cable cores 1 during operation, and the liquid cooling circulation pump can quickly dissipate heat from the cooling medium to the external environment, ensuring the normal use of the liquid-cooled cable.

The specific embodiments are as follows:

As shown in FIG. 1, an outer periphery of each cable core of a liquid-cooled cable of the present disclosure is coated with an insulating layer and a shielding structure, and an outer side of an external liquid cooling channel is provided with an inner sheath, a shielding structure, and an outer sheath layer.

As shown in FIG. 2, an outer periphery of each cable core of a liquid-cooled cable of the present disclosure is coated with an insulating layer and a shielding structure, and an outer side of an external liquid cooling channel is provided with a shielding structure and an outer sheath layer.

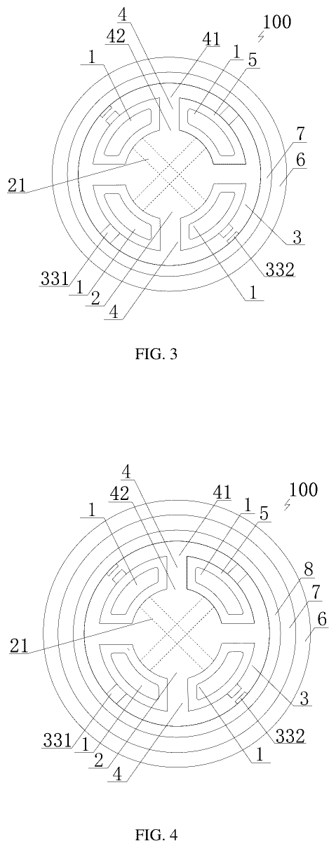

As shown in FIG. 3, an outer periphery of a cable core of a liquid-cooled cable of the present disclosure is coated with an insulating layer, and an outer side of an external liquid cooling channel is provided with a shielding structure and an outer sheath layer.

As shown in FIG. 4, an outer periphery of a cable core of a liquid-cooled cable of the present disclosure is coated with an insulating layer, and an outer side of an external liquid cooling channel is provided with an inner sheath, a shielding structure, and an outer sheath layer.

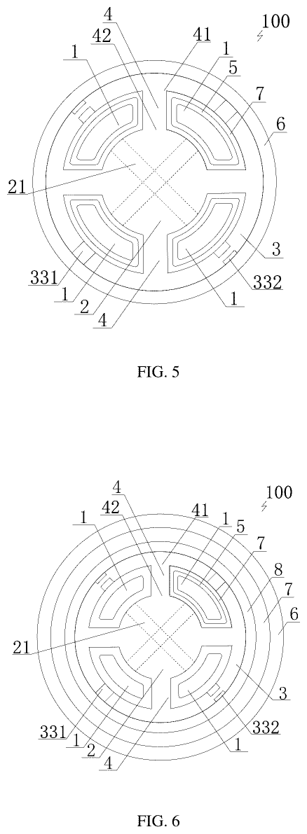

As shown in FIG. 5, an outer periphery of each cable core of a liquid-cooled cable of the present disclosure is coated with an insulating layer and a shielding structure, and an outer side of an external liquid cooling channel is provided with an outer sheath layer.

As shown in FIG. 6, an outer periphery of a cable core of a liquid-cooled cable of the present disclosure is coated with an insulating layer and a shielding structure, and an outer side of an external liquid cooling channel is provided with an inner sheath, a shielding structure, and an outer sheath layer.

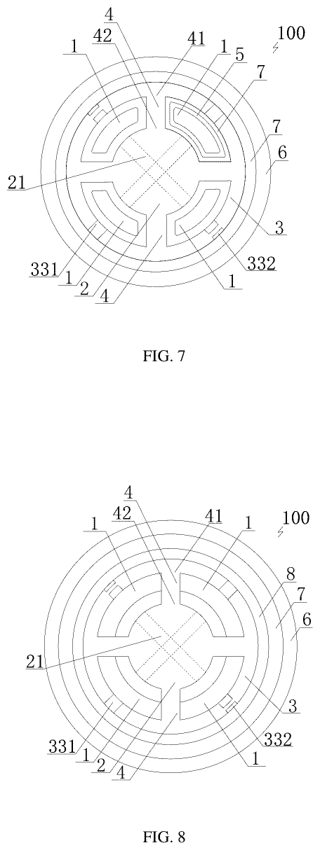

As shown in FIG. 7, an outer periphery of a cable core of a liquid-cooled cable of the present disclosure is coated with an insulating layer and a shielding structure, and an outer side of an external liquid cooling channel is provided with a shielding structure and an outer sheath layer.

As shown in FIG. 8, multiple cable cores of a liquid-cooled cable of the present disclosure are disposed in a radial direction of the liquid cooling cable, and an outer side of an external liquid cooling channel is provided with an inner sheath, a shielding structure, and an outer sheath layer.

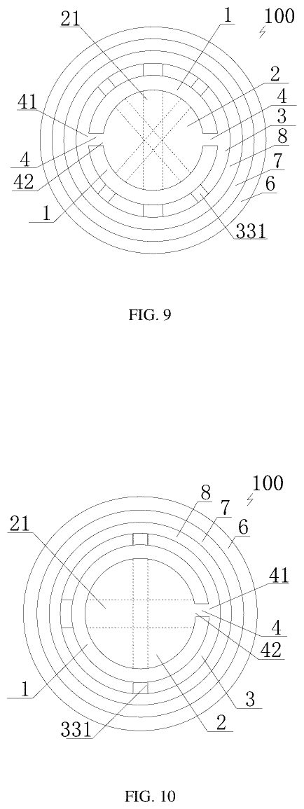

As shown in FIG. 9, each cable core of a liquid-cooled cable of the present disclosure is in a shape of a semicircular fan, and an outer side of an external liquid cooling channel is provided with an inner sheath, a shielding structure, and an outer sheath layer.

As shown in FIG. 10, a liquid-cooled cable of the present disclosure includes a cable core, and an outer side of an external liquid cooling channel is provided with an inner sheath, a shielding structure, and an outer sheath layer.

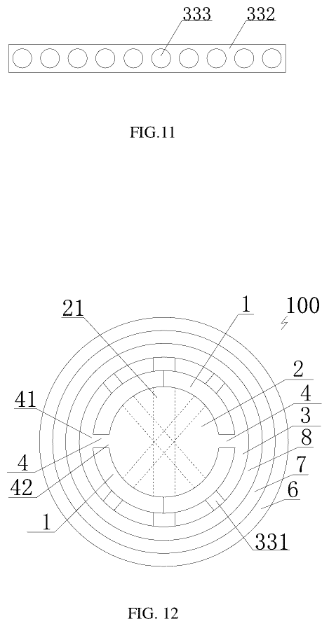

FIG. 12 is a schematic cross-sectional view where two adjacent cable cores of a liquid-cooled cable of the present disclosure form a shape of a semicircular fan, and an outer side of an external liquid cooling channel is provided with an inner sheath, a shielding structure, and an outer sheath layer.

Based on the foregoing description, the liquid-cooled cable in the present disclosure has the following beneficial effects:

In the liquid-cooled cable provided by present disclosure, the liquid cooling channels are increased inside and outside the cable cores, maximizing the cooling effect of the cables. The outer sheath layer can protect a structure therein. The cable cores in the liquid-cooled cable of the present disclosure have good heat dissipation effect, thus enhancing the flow carrying capacity of the cables and prolonging the service life.

The above descriptions are merely illustrative specific implementations of the present disclosure and are not intended to limit the scope of the present disclosure. Any equivalent changes and modifications made by those skilled in the art, without departing from the concept and principle of the present disclosure, should fall within the protection scope of the present disclosure.

1. A liquid-cooled cable, comprising a liquid cooling channel and at least one set of cable cores with a cross section in a shape of fan, wherein the liquid cooling channel comprises an internal liquid cooling channel, an external liquid cooling channel, and at least one set of connecting channels, the external liquid cooling channel communicates with the internal liquid cooling channel via the connecting channels, and a cooling medium flows in the liquid cooling channel; and the cable cores are disposed at an outer periphery of the internal liquid cooling channel and an inner periphery of the external liquid cooling channel, and the connecting channels are disposed at a radial direction of the liquid-cooled cable and separate the cable cores.

2. The liquid-cooled cable according to claim 1, wherein the external liquid cooling channel comprises a first tube body and a second tube body; the first tube body sleeves the second tube body; and the external liquid cooling channel further comprises at least one first support structure, and the first support structure is connected to an inner wall of the first tube body and an outer wall of the second tube body.

3. The liquid-cooled cable according to claim 2, wherein each of the connecting channels has a first via hole and a second via hole at two ends, the first via hole runs through a tube wall of the second tube body, and the second via hole runs through a tube wall of the internal liquid cooling channel.

4. The liquid-cooled cable according to claim 2, wherein each first support structure is a plurality of sets of columnar structures; and/or each first support structure is a strip plate-like body, and the strip plate-like body is provided with a through hole.

5. The liquid-cooled cable according to claim 1, wherein each of the connecting channels has two sets of side walls, and the two sets of side walls rotate around a central axis of the internal liquid cooling channel; or the two sets of side walls are parallel to the central axis of the internal liquid cooling channel.

6. The liquid-cooled cable according to claim 1, wherein an outer periphery of at least one of the cable cores is sleeved with an insulating layer.

7. The liquid-cooled cable according to claim 1, wherein the multiple cable cores are disposed in the radial direction of the liquid cooling cable.

8. The liquid-cooled cable according to claim 1, wherein the liquid cooling cable further comprises an outer sheath layer, and the outer sheath layer is disposed at an outermost periphery of the liquid cooling cable.

9. The liquid-cooled cable according to claim 2, wherein the liquid cooling cable further comprises a shielding structure, and an outer periphery of the first tube body is sleeved with the shielding structure; and/or an outer periphery of the at least one cable core is sleeved with an insulating layer, and an outer periphery of the at least one insulating layer is sleeved with the shielding structure.

10. The liquid-cooled cable according to claim 9, wherein the liquid cooling cable further comprises an inner sheath, the outer periphery of the first tube body is sleeved with the inner sheath, and an outer periphery of the inner sheath is sleeved with the shielding structure.

11. The liquid-cooled cable according to claim 1, wherein the internal liquid cooling channel further comprises at least one set of second support structures, the second support structure supports and connects an inner wall of the internal liquid cooling channel, the second support structure is a strip plate-like body, and the strip plate-like body is provided with a plurality of sets of through holes; and/or the second support structure is a plurality of sets of columnar structures.

12. The liquid-cooled cable according to claim 1, wherein a ratio of an inner cavity cross-sectional area of the internal liquid cooling channel to a cross-sectional area sum of the cable cores is 2% to 60%.

13. The liquid-cooled cable according to claim 1, wherein a ratio of an inner cavity cross-sectional area of the external liquid cooling channel to a cross-sectional area sum of the cable cores is 2% to 60%.

14. The liquid-cooled cable according to claim 5, wherein a ratio of a distance between two side walls of the connecting channel to a circumference of the internal liquid cooling channel is 5% to 45%.

15. The liquid-cooled cable according to claim 4, wherein a ratio of a circumferential total width of the first support structure to a circumference of the external liquid cooling channel is 4% to 54%.

16. The liquid-cooled cable according to claim 11, wherein a ratio of a circumferential total width of the second support structure to an inner diameter of the internal liquid cooling channel is 3% to 20%.

17. The liquid-cooled cable according to claim 1, further comprising a liquid cooling circulation pump, wherein the liquid cooling circulation pump communicates with the liquid cooling channel via a communication tube, and the liquid cooling circulation pump is configured to circulate and cool the cooling medium in the liquid cooling channel.

18. The liquid-cooled cable according to of claim 2, further comprising a liquid cooling circulation pump, wherein the liquid cooling circulation pump communicates with the liquid cooling channel via a communication tube, and the liquid cooling circulation pump is configured to circulate and cool the cooling medium in the liquid cooling channel.

19. The liquid-cooled cable according to of claim 3, further comprising a liquid cooling circulation pump, wherein the liquid cooling circulation pump communicates with the liquid cooling channel via a communication tube, and the liquid cooling circulation pump is configured to circulate and cool the cooling medium in the liquid cooling channel.

20. The liquid-cooled cable according to of claim 4, further comprising a liquid cooling circulation pump, wherein the liquid cooling circulation pump communicates with the liquid cooling channel via a communication tube, and the liquid cooling circulation pump is configured to circulate and cool the cooling medium in the liquid cooling channel.
